(19) United States
(12) Patent Application Publication
(10) Pub. No.: US 2025/0223844 A1
(43) Pub. Date: Jul. 10, 2025

(54) HORIZONTAL LOCKER

(71) Applicant: Linhai Sunrise Leisure Products Co.,Ltd., LINHAI CITY (CN)

(72) Inventors: Huaqiang Shen, LINHAI CITY (CN); Yilun Liu, LINHAI CITY (CN)

(21) Appl. No.: 19/091,689

(22) Filed: Mar. 26, 2025

(51) Int. Cl. E05B 65/52; E05B 37/02

(52) U.S. Cl. CPC E05B 65/52; E05B 37/02

(57) ABSTRACT

The present invention discloses a horizontal locker which includes a bottom plate, a cover plate and four side plates, where the four side plates are interconnected and then enclosed with the bottom plate to form a locker body with an upward opening; the cover plate is hinged at the opening of the locker body; telescopic support members are provided between two opposite side plates close to the cover plate and the cover plate, a first corner connector is provided at connections of the side plates for fixing adjacent two side plates, and the first corner connector is a long-strip structure. The horizontal locker is not only lightweight, but also ensures strength.

### TECHNICAL FIELD

The present invention relates to the technical field of storage boxes, in particular to a horizontal locker.

### BACKGROUND

At present, storage boxes and cabinets used in outdoors or warehouses on the market usually have a relatively simple structure. Generally, a plurality of side wall plates are fixed on a bottom plate, a box cover is added, and the side wall plates are interconnected. Although such storage boxes and cabinets have a simple structure, most of them are bulky and occupy a large area, which is inconvenient to handle and load and unload. It is very time-consuming and labor-intensive for storage and transportation. Some storage boxes and cabinets are made of steel plates, resulting in good bearing capacity but poor portability and flexibility. Some storage boxes and cabinets are made of plastic, resulting in light weight but limited strength. Especially in outdoor environments, storage boxes and cabinets are prone to damage.

### SUMMARY

An object of the present invention is to provide a horizontal locker designed to solve the above-mentioned technical deficiencies.

The present invention designs a horizontal locker which includes a bottom plate, a cover plate and four side plates, where the four side plates are interconnected and then enclosed with the bottom plate to form a locker body with an upward opening; the cover plate is hinged at the opening of the locker body; telescopic support members are provided between two opposite side plates close to the cover plate and the cover plate, a first corner connector is provided at connections of the side plates for fixing adjacent two side plates, the first corner connector is a long-strip structure, and the first corner connector extends along a height direction of the locker body.

The technical effect of the present invention is as follows: the locker consists of a cover plate, a bottom plate and four side plates; the cover plate, the bottom plate and the side plates are all made of corrugated contour plates, which is not only lightweight, but also ensures strength; the adjacent side plates are fixedly connected by a first corner connector, and the first corner connector is of a long-strip plate body structure and fully covers the height of the side plates, which ensures connection stability between the side plates, thus ensuring the firmness and further simplifying the structure and reducing the weight; a support member is provided between the cover plate and the locker body, and the support part is telescopic, so that opening and closing of the cover plate can be more labor-saving and safer; and a lock body structure is provided between the cover plate and the locker body, and the lock body structure can adopt a rotating snap hook structure or a rotating bolt structure, which is simple and stable in structure and easy to realize.

### BRIEF DESCRIPTION OF THE DRAWINGS

FIG. 1 is a schematic diagram of an overall structure with a cover plate opened;

FIG. 2 is a schematic diagram of the overall structure with the cover plate opened from another perspective;

FIG. 3 is a structural schematic diagram of a lock body structure in Embodiment 1;

FIG. 4 is a structural diagram of a locker body according to Embodiment 2;

FIG. 5 is a structural schematic diagram of a combination lock surface;

FIG. 6 is a structural sectional view of a cover plate; and

FIG. 7 is a structural sectional view of a side plate.

Reference numerals in the drawings: 1. bottom plate; 2. cover plate; 21. outer plate; 22. inner plate; 23. outer side surface; 24. inner side surface; 25. second corner connector; 3. side plate; 4. opening; 5. support member; 6. first corner connector; 8. anti-impact corner guard; 9. mounting plate 10. first combination lock surface; 11. snap hook; 12. hook mouth 13. ring clasp; 14. second combination lock surface; 15. rotating member; 16. positioning rod; 17. bent portion; and 18. support foot.

### DESCRIPTION OF THE EMBODIMENTS

The technical solutions in the embodiments of the present invention will be clearly and completely described below in conjunction with the accompanying drawings in the embodiments of the present invention. Obviously, the described embodiments are only part but not all of the embodiments of the present invention. All other embodiments obtained by a person of ordinary skill in the art based on the embodiments of the present invention without creative efforts shall fall within the protection scope of the present invention.

### Embodiment 1

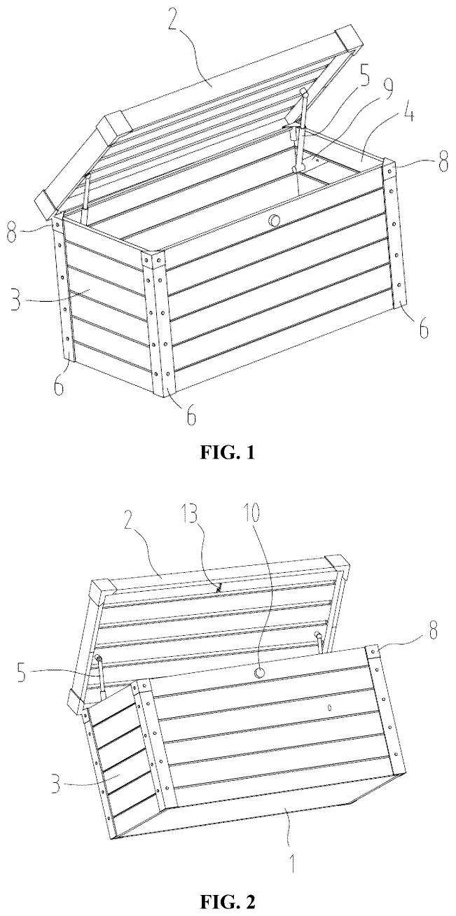

As shown in FIGS. 1 and 2, the present invention includes a bottom plate 1, a cover plate 2 and four side plates 3; the four side plates 3 are interconnected and then enclosed with the bottom plate 1 to form a locker body with an upward opening 4; the bottom plate 1, the cover plate 2 and the side plates 3 are all made of metal corrugated contour plates, so that edges of the bottom plate 1 and the side plates 3 can be mutually affixed and fixedly connected by fasteners after bending; and the four side plates 3 are interconnected to form a cuboid structure, side ends of adjacent two side plates 3 are interconnected, and a resulting connection is provided with a first corner connector 6, that is, the adjacent two side plates 3 are fixedly connected by the first corner connector 6. In the present embodiment, the first corner connector 6 is a long-strip structure, the first corner connector 6 includes two long strip-shaped support plates, the support plates extend along a height direction of the locker body, the two support plates are integrally connected at an angle formed by the adjacent two side plates 3, that is, opposite side walls of the two support plates are respectively affixed to outer peripheral walls of the adjacent two side plates 3, and then fixed by fasteners which may be screws, bolts, etc.; and a width of the two support plates is larger than a thickness of the side plates 3, ensuring that the first corner connector 6 can fully connect and cover a connection of the two side plates 3, and fix the adjacent side plates 3. Furthermore, use of the first corner connector 6 also improve strength and load-carrying capacity of the locker body.

The cover plate 2 is hinged at the opening 4 of the locker body by a hinge as a box cover, and a telescopic support member 5 is provided between two opposite side plates 3 close to the cover plate 2 and the cover plate 2, and the support member 5 is extended and retracted with opening and closing of the cover plate 2, so that the support member 5 can not only support the cover plate 2, but also makes manual opening and closing of the cover plate 2 more labor-saving.

A top end of each of the first corner connectors 6 extends to the opening 4 of the locker body, that is, the top end of the first corner connector 6 is flush with the opening 4 of the locker body, and a connection between the top end of the first corner connector 6 and the corresponding side plate 3 is provided with an anti-impact corner guard 8, the anti-impact corner guard 8 wraps the connection between the adjacent two side plates 3 and the top end of the support plate, so that the four corners of the opening 4 of the locker body are wrapped with the anti-impact corner guard 8, and the anti-impact corner guard 8 is fixedly connected to the side plates 3 by fasteners to cover sharp corners of the locker body for protection.

Further, inner walls of the two opposite side plates 3 close to the cover plate 2 are provided with a mounting plate 9 respectively, a fixed end of the support member 5 is connected to the mounting plate 9, a telescopic end of the support member 5 is connected to the cover plate 2, so that the support member 5 is not directly connected with the side plate 3. The mounting plate 9 serves as a reinforcing rib, which not only strengthens stability of the support member 5, but also improves strength of the locker body, avoiding deformation of the locker body at the connection of the support plate, and facilitating mounting of the support member 5.

Further, the support member 5 is a hydraulic telescopic rod, one end of the hydraulic telescopic rod is movably connected to the side plate 3, and the other end of the hydraulic telescopic rod is movably connected to the cover plate 2. In the present embodiment, both ends of the hydraulic telescopic rod can be connected to the side plate 3 and the cover plate 2 through a ball joint or a universal adapter respectively, so that the hydraulic telescopic rod can be freely extended and retracted with the opening and closing of the cover plate 2. The use of the hydraulic telescopic rod provides damping effect during the opening and closing of the cover plate 2, making the opening and closing of the cover plate 2 more labor-saving and safer, and avoiding hand from getting caught. Of course, the support member 5 may be an electric telescopic rod, a pneumatic telescopic rod, or the like.

A lock structure is provided between the side plate 3 and the cover plate 2 located in front to lock the cover plate 2.

In the present embodiment, the lock body structure includes a first combination lock surface 10, a snap hook 11 and a ring clasp 13; the first combination lock surface 10 is located on an outside of the side plate 3, the snap hook 11 is located on an inside of the side plate 3 and rotationally connected to the first combination lock surface 10, and the snap hook 11 is rotated by operating the first combination lock surface 10; as shown in FIG. 3, the ring clasp 13 is an annular rod-shaped member, and both ends of the ring clasp 13 are connected to a top inner wall of the cover plate 2; one side of the snap hook 11 is provided with a hook mouth 12, after the snap hook 11 is rotated, the hook mouth 12 is snapped into the ring clasp 13, so that the snap hook 11 is hooked to the ring clasp 13, in this case, the cover plate 2 and the cabinet body are locked; and when the snap hook 11 is rotated in the reverse direction, the snap hook 11 is disengaged from the ring clasp 13, in this case, the cover plate 2 is in an unlocked state and can be opened and closed freely.

Further, as shown in FIG. 6, the cover plate 2 includes an outer plate 21 and an inner plate 22, both the outer plate 21 and the inner plate 22 are metal corrugated contour plates, an edge of the outer plate 21 is bent twice to form an outer side surface 23 and an inner side surface 24, a top end of the inner side surface 24 abuts against the inner plate 22, an angle between the inner side surface 24 and the inner plate 22 is 90 degrees, and a connection between the inner side surface 24 and the inner plate 22 is affixed by a long-strip second corner connector 25, and then fixed by fasteners such as rivets.

Further, as shown in FIG. 7, a bottom edge of the side plate 3 is bent inward to form a bent portion 17, the bent portion 17 and the bottom plate 1 are affixed to each other and fixed by fasteners such as rivets, and support legs 18 are further provided on the bent portion 17.

### Embodiment 2

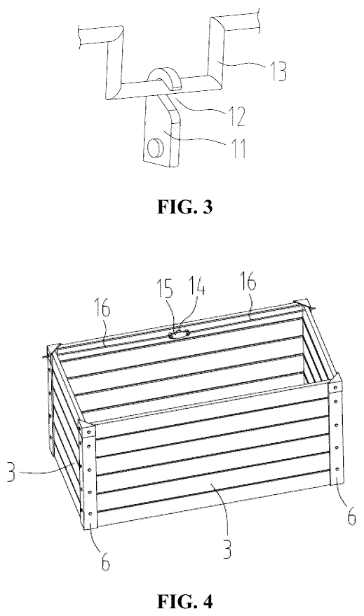

The present embodiment is substantially the same as Embodiment 1, and the difference lies in the lock body structure. In the present embodiment, the lock body structure includes a second combination lock surface 14, a rotating member 15 and a positioning rod 16, the second combination lock surface 14 is located on the outside of the side plate 3, the rotating member 15 is located on the inside of the side plate 3 and is rotatably connected to the second combination lock surface 14, the rotating member 15 is rotated by operating the second combination lock surface 14, and the rotating member 15 is transmission connected with the positioning rod 16. In the present embodiment, as shown in FIG. 4, there are two positioning rods 16 which are symmetrically connected to both sides of the rotating member 15; the two positioning rods 16 are extended and retracted synchronously through the rotation of the rotating member 15; the side plates 3 are provided with a first positioning hole for the positioning rods 16 to pass through, that is, the two opposite side plates 3 of the locker body are provided with the first positioning hole, and the cover plate 2 is provided with a second positioning hole communicated with the first positioning hole; one end of the positioning rod 16 is rotatably connected to the rotating member 15, and the other end is inserted into the first positioning hole; when the positioning rod 16 is extended through the second positioning hole by rotating the rotating member 15, the cover plate 2 and the locker body are locked; and when the positioning rod 16 is retracted from the second positioning hole by rotating the rotating member 15 in the reverse direction, the cover plate 2 and the locker body are unlocked. It should be noted that the transmission connection between the rotating member 15 and the positioning rod 16 is a conventional technique, and will not be repeated here.

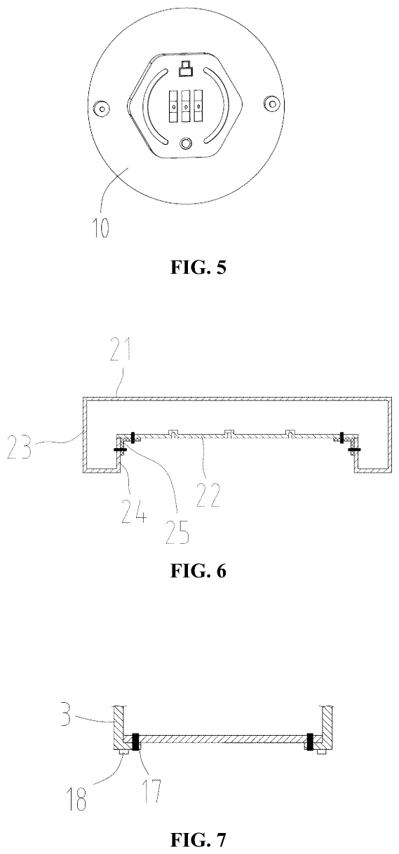

It should be noted that, as shown in FIG. 5, the first lock combination surface 10 and the second combination lock surface 14 are both of the same structure, and the combination lock surfaces used to distinguish the two lock body structures are operated to drive the snap hook 11 and the rotating member 15 to rotate. This is a conventional transmission structure, and will not be repeated here. As shown in FIG. 5, the first combination lock surface 10 and the second combination lock surface 14 can be of conventional digital combination locks. The advantages of using the combination lock body structure are that there is no need to carry a key with you, so there is no need to worry about losing the key, and it is convenient for others to use. The digital combination lock is a conventional technique, and the specific structure will not be described here.

The present invention is not limited to the above-mentioned preferred embodiments, and any other products in various forms can be obtained by anyone in the light of the present invention, but any changes in the shape or structure thereof, which have the same or similar technical solutions as those of the present application, fall within the scope of the present invention.

What is claimed is:

1. A horizontal locker, comprising a bottom plate, a cover plate and four side plates, wherein the four side plates are interconnected and then connected with the bottom plate to form a locker body, the locker body has an opening arranged upward, the cover plate is hinged to the locker body, a telescopic support member is connected between the cover plate and the locker body, the support member is arranged close to a hinge axis of the cover plate to support when the cover plate is opened, a first corner connector is provided at a connection between adjacent two side plates, and the first corner connector is a long-strip structure and extends along a height direction of the locker body.

2. The horizontal locker according to claim 1, wherein the bottom plate, the cover plate and the side plates are all composed of metal corrugated contour plates.

3. The horizontal locker according to claim 2, wherein the first corner connector comprises two long-shaped support plates, and the two support plates are integrally formed at an angle formed by adjacent two side plates.

4. The horizontal locker according to claim 3, wherein the support plates and the locker body are fixedly connected by fasteners.

5. The horizontal locker according to claim 1, wherein each of the first corner connectors extends to the opening of the locker body, and an anti-impact corner guard is provided at a connection between at least one of the first corner connectors and the corresponding side plate.

6. The horizontal locker according to claim 1, wherein a mounting plate is provided on an inner wall of the side plate, one end of the support member is mounted on the mounting plate, and the other end of the support member is mounted on the cover plate.

7. The horizontal locker according to claim 6, wherein the support member is a hydraulic telescopic rod, and both ends of the hydraulic telescopic rod are movably connected to the side plate and the cover plate respectively.

8. The horizontal locker according to claim 1, wherein a lock structure is provided between the side plate and the cover plate.

9. The horizontal locker according to claim 8, wherein the lock body structure comprises a first combination lock surface, a snap hook and a ring clasp, the first combination lock surface is located on an outside of the side plate, the snap hook is located on an inside of the side plate and is rotatably connected to the first combination lock surface, the snap hook is rotated by operating the first combination lock surface, the ring clasp is connected to an inner wall of the cover plate, and the snap hook is hooked to or disengaged from the ring clasp by rotation.

10. The horizontal locker according to claim 8, wherein the lock body structure comprises a second combination lock surface, a rotating member, and a positioning rod; the second combination lock surface is located on the outside of the side plate, and the rotating member is located on the inside of the side plate and is rotatably connected to the second combination lock surface; the rotating member is rotated by operating the second combination lock surface, and the rotating member is transmission connected with the positioning rod; the positioning rod extends and retracts through rotation of the rotating member; the side plate is provided with a first positioning hole for the positioning rod to pass through, and the cover plate is provided with a second positioning hole communicated with the first positioning hole; and when the positioning rod is extended through the second positioning hole, the cover plate and the locker body are locked, and when the positioning rod is retracted from the second positioning hole, the cover plate and the locker body are unlocked.

11. The horizontal locker according to claim 1, wherein the cover plate comprises an outer plate and an inner plate, an edge of the outer plate is bent twice to form an outer side surface and an inner side surface, the inner side surface abuts against the inner plate, and a connection between the inner side surface and the inner plate is fixedly connected by a second corner connector.
